(19) United States
(12) Patent Application Publication
(10) Pub. No.: US 2025/0018481 A1
(43) Pub. Date: Jan. 16, 2025

(54) BANDSAW

(71) Applicant: BLACK & DECKER INC., New Britain, CT (US)

(72) Inventors: Kyle Christophersen, Lutherville-Timonium, MD (US); Ryan Ye, Towson, MD (US); Luke Yuan, Towson, MD (US)

(21) Appl. No.: 18/772,072

(22) Filed: Jul. 12, 2024

Related U.S. Application Data
(60) Provisional application No. 63/513,640, filed on Jul. 14, 2023.

(51) Int. Cl. B23D 53/12; B23D 55/06

(52) U.S. Cl. CPC B23D 53/12; B23D 55/065

(57) ABSTRACT

The present disclosure is directed to a bandsaw. The bandsaw may be cordless bandsaw utilizing a battery pack to provide power to an electric motor. The electric motor may drive an transmission. The transmission may be mechanically coupled to a drive wheel. The drive wheel, in conjunction with a driven wheel turn a blade for a cutting operation. The bandsaw may include a base for housing the drive and driven wheels. The base may also include an integrated transmission housing for housing the transmission.

### RELATED APPLICATIONS

This application claims the benefit of priority under 35 U.S.C. § 119(e) to U.S. Provisional Patent Application Ser. No. 63/513,640, filed Jul. 14, 2023, titled “Bandsaw,” which is incorporated by reference in its entirety.

### TECHNICAL FIELD

This application relates to a bandsaw and a method for making and using a bandsaw.

### BACKGROUND

Generally, improving the ergonomics of a power tool is almost always paramount. Typically providing a more compact power tool is advantageous. Decreasing the size of a transmission and reducing part count can also be advantageous.

For power tools and hand tools used in construction at high elevation, tool operators often fasten or tether a safety lanyard or hook to the tool to protect the tool, as well as those working at lower levels, in the event the tool is dropped. Without a tether connection, the drop often damages the tool even without direct impact with the ground, as the kinetic energy of the tool is transferred to the tool housing. However, many conventional tools do not provide adequate locations to attach a lanyard, and the user is forced to hook the lanyard directly to, for example, the tool handle. Furthermore, a lanyard suitable for a small tool might not have sufficient strength to handle the weight of a heavier and bulkier tool. In the event of a fall, even without impact with the ground, the energy from the fall often damages the internal components of the tool. What is desired is to provide a connectivity mechanism on the tool itself that would encompass the energy-absorbing characteristics needed to protect the tool.

In a bandsaw, when a blade slips relative to a tire, friction and heat may be generated. Any generated heat may damage the tire and reduce the tire's useful life. Also, a user may be frustrated if the blade slips and stops moving through the work piece. Also, if a blade slips relative to the tire, the amount of torque transfer between the tire and blade may be reduced. Any reduction in torque transfer may reduce the effectiveness of a cut by the blade.

Typically, portable band saws have a base that acts as a main enclosure or the base can have front and rear bumpers attached thereto. The bumpers can be made from a material different than the base. The construction is based on the geometry and mechanical properties of the bumper material to withstand a drop. To improve drop results, one can optimize the geometry of the bumper and/or use materials for the bumper with better properties.

### SUMMARY

An aspect of the present invention includes a bandsaw including a transmission received in a housing integral to a base of the bandsaw. An example embodiment of the bandsaw comprises a motor, a transmission coupled to the motor, a base, the base including an integrated transmission housing, the transmission received in the integrated transmission housing, a drive wheel, the drive wheel coupled to the transmission, a driven wheel, a blade positioned about the drive wheel and the driven wheel.

The aforementioned example embodiment may further comprise a cover attached to an outer opening of the transmission housing.

A bandsaw of the aforementioned example embodiment wherein the cover includes a central opening to receive a motor output gear.

A bandsaw of the aforementioned example embodiment wherein the transmission includes a first planet gear set and a first carrier, the first planet gear set received on a first side of the first carrier, the motor output gear received within a central area formed by the first planet gear set in driving communication with the first planet gear set.

A bandsaw of the aforementioned example embodiment wherein the first carrier includes a first central sun gear on a second side of the first carrier, the second side of the first carrier being opposed to the first side of the first carrier, the first planet gear set in driving communication with the first carrier and the first central sun gear.

A bandsaw of the aforementioned example embodiment wherein the transmission includes a second planet gear set and a second carrier, the second planet gear set received on a first side of a second carrier, the first central sun gear received within a central area formed by the second planet gear set in driving communication with the second planet gear set.

A bandsaw of the aforementioned example embodiment wherein the second carrier includes a second sun gear on a second side of the second carrier, the second side of the second carrier being opposed to the first side of the second carrier, the second planet gear set in driving communication with the second carrier and the second central sun gear.

A bandsaw of the aforementioned example embodiment wherein the transmission includes a third planet gear set and a third carrier, the third planet gear set received on a first side of a third carrier, the second central sun gear received within a central area formed by the third planet gear set in driving communication with the third planet gear set.

A bandsaw of the aforementioned example embodiment wherein the third carrier includes a central opening, the third planet gear set is in driving communication with the third carrier.

A bandsaw of the aforementioned example embodiment wherein the transmission includes an arbor, the arbor including a first end 160a, the first end of the arbor received in the central opening of the third carrier, such that the third carrier is in driving communication with the arbor.

A bandsaw of the aforementioned example embodiment wherein the first end of the arbor has a shape corresponding to the central opening of the third carrier such that when the third carrier rotates the third carrier drives the arbor.

A bandsaw of the aforementioned example embodiment wherein the arbor includes a second end received in an opening of the drive wheel in driving communication with the drive wheel.

A bandsaw of the aforementioned example embodiment wherein the transmission includes a first ring gear and wherein the first planet gear set, the first carrier, the second planet gear set, and the second carrier are received within an interior volume of the first ring gear.

A bandsaw of the aforementioned example embodiment wherein teeth of the first planet gear set and teeth of the second planet gear set are engaged with teeth of the first ring gear to enable relative movement between the first planet gear set and the second planet gear set and the first ring gear.

A bandsaw of the aforementioned example embodiment wherein the transmission includes a second ring gear and wherein the third planet gear set and the third carrier are received within an interior volume of the second ring gear.

A bandsaw of the aforementioned example embodiment wherein teeth of the third planet gear set are engage with teeth of the second ring gear to enable relative movement between the third planet gear set and the second ring gear.

A bandsaw of the aforementioned example embodiment wherein the transmission housing receives and holds the first ring gear and the second ring gear.

A bandsaw of the aforementioned example embodiment wherein the first ring gear includes a set of tongues on an exterior surface of the first ring gear and the transmission housing includes a set of channels on an interior surface of the transmission housing, the set of tongues of the first ring gear received in the set of channels of the transmission housing thereby preventing the first ring gear from moving relative to the transmission housing.

A bandsaw of the aforementioned example embodiment wherein the second ring gear includes a set of tongues on an exterior surface of the second ring gear and the transmission housing includes a set of channels on an interior surface of the transmission housing, the set of tongues of the second ring gear received in the set of channels of the transmission housing, thereby preventing the second ring gear from moving relative to the transmission housing.

A bandsaw of the aforementioned example embodiment wherein the first ring gear has an exterior diameter and the second ring gear has an exterior diameter, the exterior diameter of the first ring gear and the exterior diameter of the second ring gear being approximately equal and the transmission housing has an interior diameter, the exterior diameter of the first ring gear, the exterior diameter of the second ring gear and the interior diameter of the transmission housing being approximately equal.

These and other advantages and features will be apparent from the description and the drawings.

### BRIEF DESCRIPTION OF THE DRAWINGS

FIG. 1 is a top plan view of an example bandsaw of the present disclosure.

FIG. 2 is a bottom plan view of the bandsaw of FIG. 1.

FIG. 3 is front elevation view of the bandsaw of FIG. 1.

FIG. 4 is a left side elevation view of the bandsaw of FIG. 1.

FIG. 5 is a rear elevation view of the bandsaw of FIG. 1.

FIG. 6 is a right side elevation view of the bandsaw of FIG. 1.

FIG. 7 is a top, front, left side isometric view of the bandsaw of FIG. 1.

FIG. 8 is top, rear, left side isometric view of the bandsaw of FIG. 1.

FIG. 9 is an isometric view of an example base with an example transmission and motor of the bandsaw of FIG. 1.

FIG. 10 is an isometric view of the base and the transmission of FIG. 9.

FIG. 11 is an exploded isometric view of the base, the transmission and the motor of FIG. 9.

FIG. 12 is a cross-sectional view taken along section line A-A of FIG. 4.

FIG. 13 is a cross-sectional view taken along section line B-B of FIG. 1.

FIG. 14A is a top plan view of an example blade guard of the bandsaw of FIG. 1.

FIG. 14B is a detail view of Detail A of FIG. 14A.

FIG. 15 is a bottom isometric view of another example bandsaw of the present disclosure.

FIG. 16 is a detail view of a blade and a tire of the bandsaw of FIG. 15.

FIG. 17 is a top plan view of another example bandsaw of the present disclosure.

FIG. 18 is top, front, left isometric view of the bandsaw of FIG. 17.

FIG. 19 is a top plan view of an example bumper of the bandsaw of FIG. 17.

FIG. 20 is a bottom isometric view of the bumper of FIG. 19.

FIG. 21 is a bottom plan view of the bumper of FIG. 19.

FIG. 22 is a cross-sectional view taken along section line C-C of FIG. 19.

FIG. 23 is a left side elevation view of another example bandsaw of the present disclosure.

FIG. 24 is a top plan view of the bandsaw of FIG. 23.

FIG. 25 is a top, front, left side isometric view of the bandsaw of FIG. 23.

FIG. 26A is a top plan view of the bandsaw of FIG. 23 before drop.

FIG. 26B is a top plan view of the bandsaw of FIG. 23 after drop.

FIG. 27 is a rear, right side isometric view of another example bandsaw of the present disclosure.

FIG. 28 is a partial top plan view of the bandsaw of FIG. 27.

FIG. 29 is a top, right side view of another example bandsaw of the present disclosure with an example hang hook in a first position.

FIG. 30 is a top, right side view of the bandsaw of FIG. 29 with the hang hook in a second position.

FIG. 31 is a right side elevation view of the bandsaw of FIG. 29.

FIG. 32 is a section view of the hang hook of FIG. 29.

FIG. 33 is a top plan view of another example bandsaw of the present disclosure.

FIG. 34 is bottom, left side isometric view of the bandsaw of FIG. 33.

FIG. 35 is an isometric view of an example material catch of the bandsaw of FIG. 34.

FIG. 36 is an example coil spring of the present disclosure.

FIGS. 37A-37D are various isometric views of an assembly of an example lanyard of the present disclosure.

FIG. 38A is an elevation view of the lanyard of FIG. 37D.

FIG. 38B is a cross-sectional view taken along section line D-D of FIG. 38A.

FIG. 38C is a plan view of the lanyard of FIG. 37D.

FIG. 39 is a top, rear, left side isometric view of the lanyard of FIG. 37D prior to assembly to the bandsaw of FIG. 1.

FIG. 40 is a top, rear, left side isometric view of the lanyard of FIG. 37D during assembly to the bandsaw of FIG. 1.

FIG. 41 is a top, rear, left side isometric view of the lanyard of FIG. 37D assembled to the bandsaw of FIG. 1.

FIG. 42A is a top plan view of the assembled lanyard and bandsaw of FIG. 41.

FIG. 42B is a cross-sectional view of the assembled lanyard and bandsaw taken along section line E-E of FIG. 42A.

FIG. 43 is a top view of the lanyard of FIG. 37D prior to assembly to another example bandsaw of the present disclosure.

FIG. 44 is a left side elevation view of the lanyard of FIG. 37 assembled to the bandsaw of FIG. 43.

### DETAILED DESCRIPTION

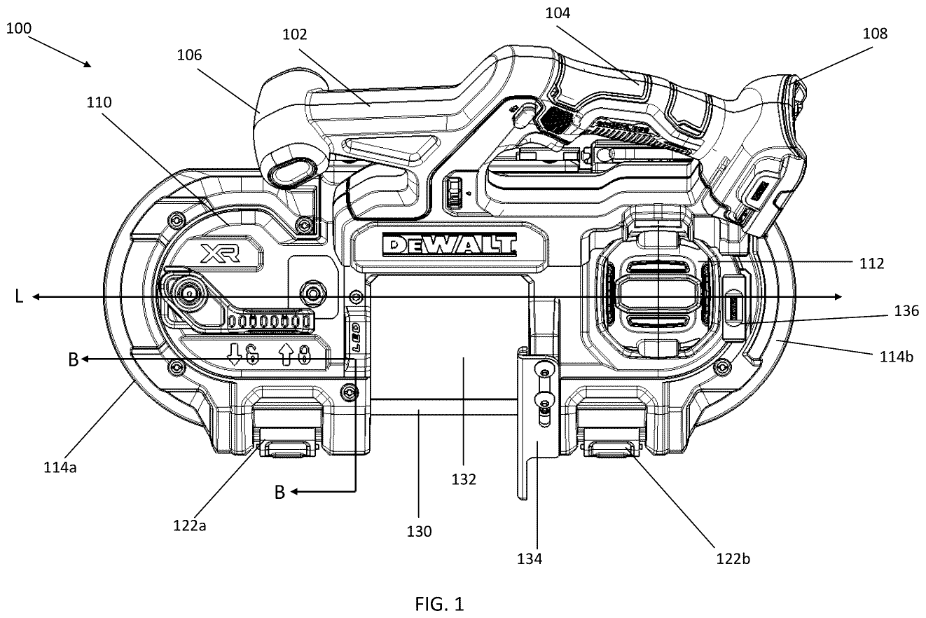

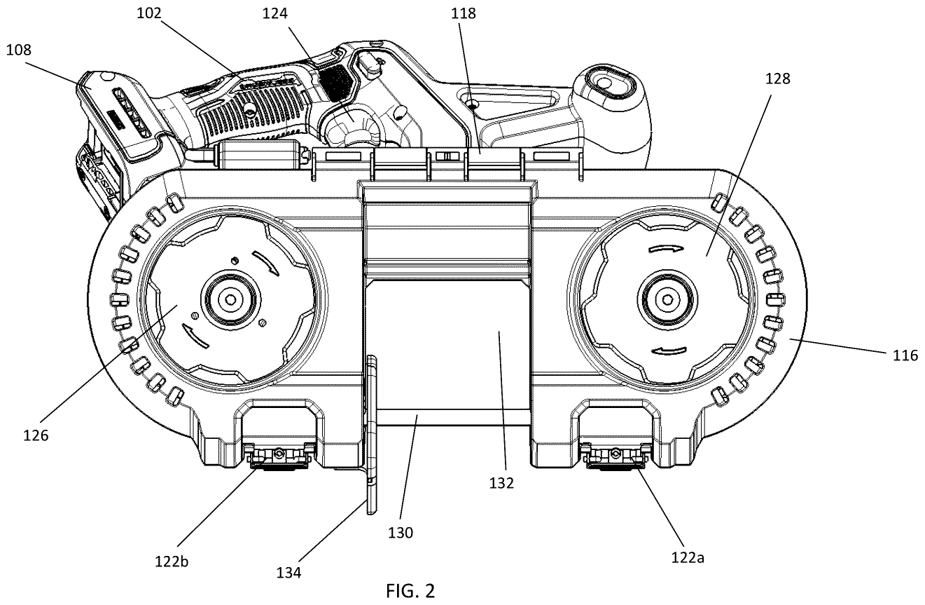

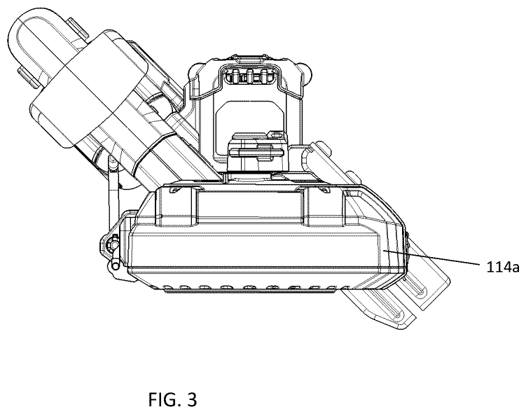

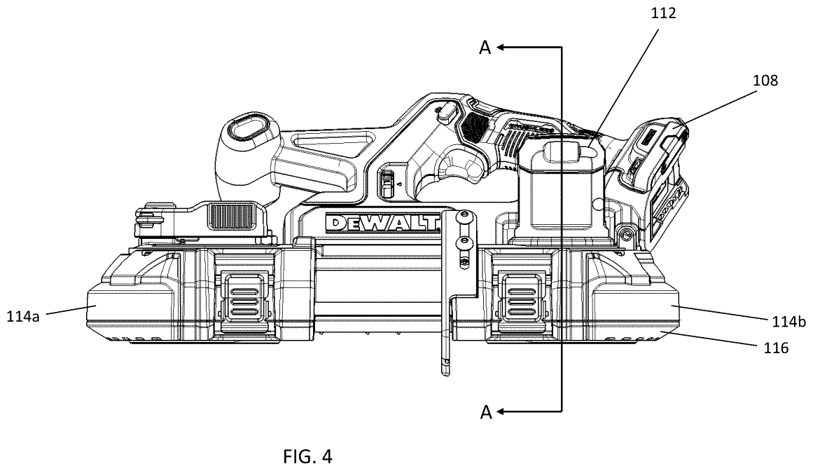

Referring to FIG. 1 through FIG. 6, there is illustrated an example bandsaw 100 of the present disclosure. The bandsaw 100 may include a handle assembly 102. The handle assembly 102 may include a primary handle 104 and a secondary handle 106. The bandsaw 100 may also include a battery pack receptacle 108 coupled to the primary handle 104. The battery pack receptacle 108 is configured to receive a battery pack to provide power to the bandsaw 100. The bandsaw 100 may also include a base 110 coupled to the handle assembly 102. The bandsaw 100 may also include a motor housing 112 coupled to the base 110. The motor housing 112 houses a motor—described in more detail below. The bandsaw 100 may also include a first (or front) bumper 114a attached to a front/forward side of the base 110 and a second (or rear) bumper 114b attached to rear/rearward side of the base 110. The bandsaw 100 may also include a blade guard 116. The blade guard 116 may be attached to the base 110. The blade guard 116 may be rotatable attached to the base 110 by, for example, a hinge 118. A pin 120 holds a blade guard portion of the hinge 118 to a base portion of the hinge 118. The pin 120 has a longitudinal axis. The hinge 118 and pin 120 allow the blade guard 116 pivot about the pin 120 and to be rotatably moved relative to the base 110. The bandsaw may also include a latch system for affixing or holding the blade guard 116 to the bae 110. The latch system may include a first latch 122a and a second latch 122b. The bandsaw 100 may also include a trigger 124 to enable a user to operate the bandsaw 100. In other words, the trigger 124 operates as a switch to electrically couple a battery pack and a motor. The bandsaw 100 may also include a drive wheel 126. The drive wheel 126 is mechanically coupled to a transmission, as described in more detail below. The bandsaw may also include a driven wheel 128. The driven wheel 128 is mechanically coupled to the drive wheel 126 by a blade 130. The bandsaw 100 may also include a first tire 131a about the drive wheel 126 and a second tire 131b about the driven wheel 128. The tires 131a, 131b may be made of a rubber material. The first tire 131a is positioned between the drive wheel 126 and the blade 130 and the second tire 131b is positioned between the driven wheel 128 and the blade 130. As such, the blade 130 touches the tires 131a, 131b. The base 110 and the blade guard 116 may be formed to create a throat 132. The throat 132 provides an opening through which the blade 130 may pass to enable cutting of a workpiece. The bandsaw 100 may also include a shoe 134 attached to the base 110. The shoe 134 may be positioned within the throat 132. The shoe 134 provides a surface upon which a workpiece may rest during a cutting application. The bandsaw 100 may also include a tethering attachment assembly screw boss 136. The tethering attachment assembly screw boss 136 may be configured to couple a tethering attachment assembly to the bandsaw 100, as described in more detail below.

As illustrated in FIG. 9, the base 110 of the bandsaw 100 may include an integrated transmission housing (also referred to as a transmission receptacle or a gear housing) 138. The integrated housing 138 may provide for improved ergonomic design and life of a planetary transmission 140 for the bandsaw 100. The bandsaw 100 may include a motor 139—the motor 139 is housed in the motor housing 112.

The bandsaw base 110 may be made of a metal material, for example aluminum. The bandsaw base 110 may be formed, for example, by a casting process. The transmission receptacle/gear housing 138 may be formed integrally with the base 110.

As illustrated in FIG. 10, the bandsaw 100 may include a cover 141 that may be attached to the transmission housing 138. The cover 141 may include a central opening to receive a motor output gear 143.

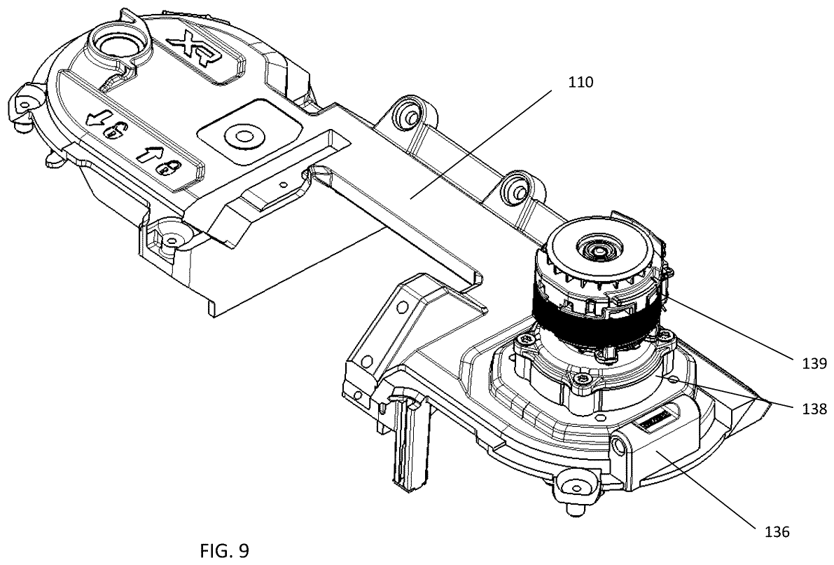

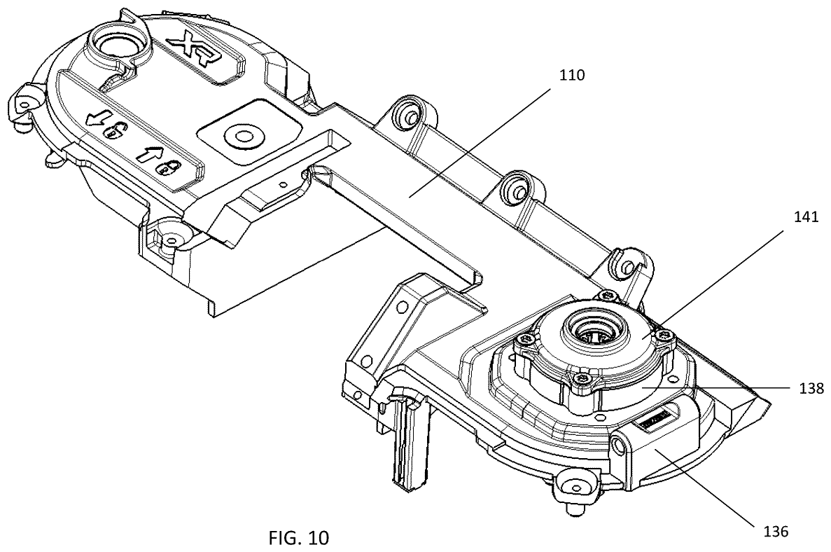

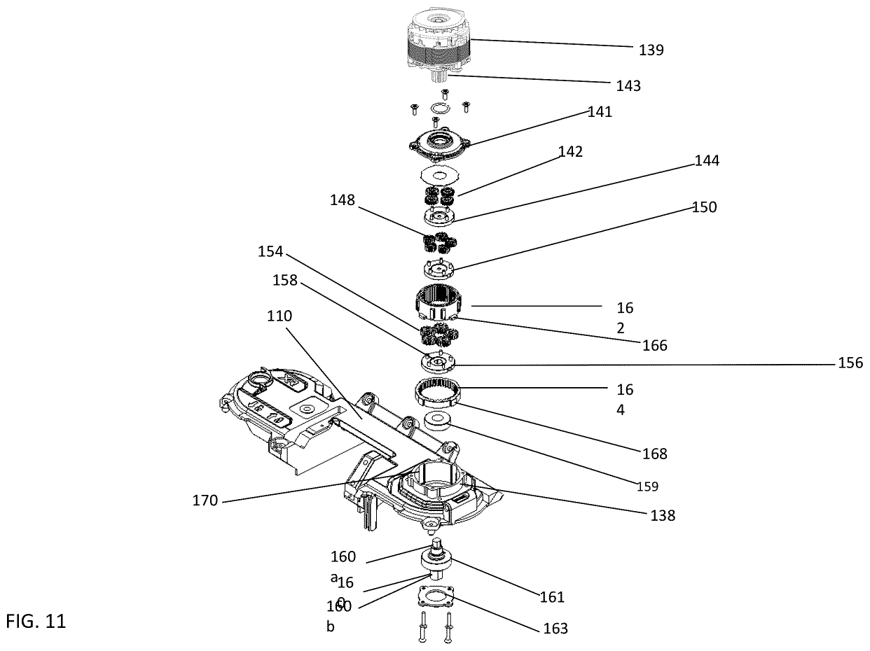

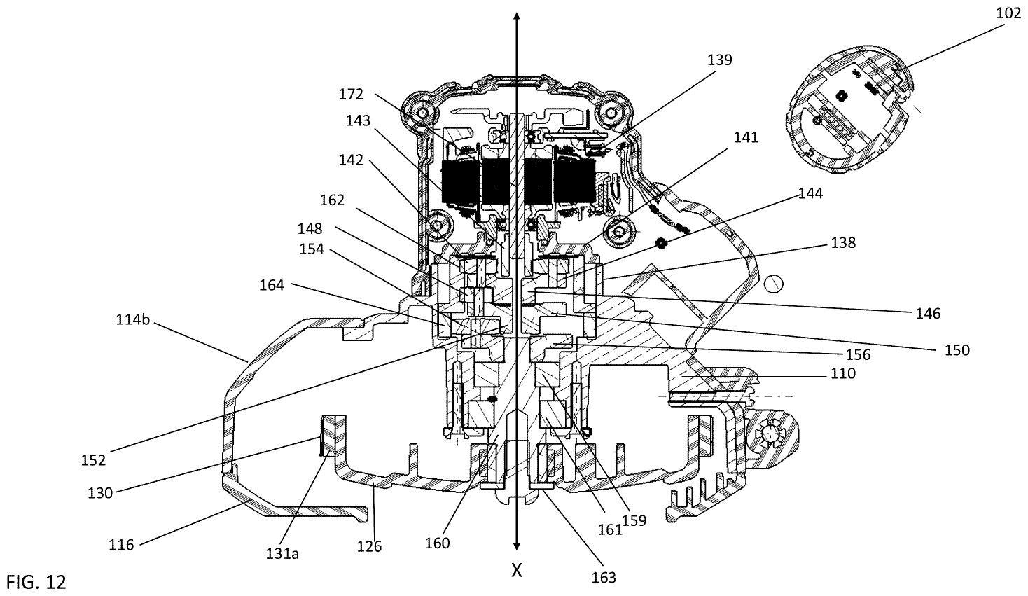

As illustrated in FIGS. 11 and 12, the transmission 140 may include a first planet gear set 142. The first planet gear set 142 may be received on a first side of a first carrier 144. The motor output gear 143 may be received within a central area formed by the first planet gear set 142. When the motor 139 is operated the motor output gear 143 may drive (rotate) the first planet gear set 142.

The first carrier 144 may include a first central sun gear 146 on a second side of the first carrier 144—the second side of the first carrier 144 being opposed to the first side of the first carrier 144. When the first planet gear set 142 is driven (rotated) the first planet gear set 142 may drive (rotate) the first carrier 144 and the first central sun gear 146.

The transmission 140 may also include a second planet gear set 148. The second planet gear set 148 may be received on a first side of a second carrier 150. The first central sun gear 146 may be received within a central area formed by the second planet gear set 148. When the first central sun gear 146 is driven (rotated) the first sun gear 146 may drive (rotate) the second planet gear set 148.

The second carrier 150 may include a second sun gear 152 on a second side of the second carrier 150—the second side of the second carrier 150 being opposed to the first side of the second carrier 150. When the second planet gear set 148 is driven (rotated), the second planet gear set 148 may drive (rotate) the second carrier 150 and the second sun gear 152.

The transmission 140 may include a third planet gear set 154. The third planet gear set 154 may be received on a first side of a third carrier 156. The second central sun gear 152 may be received within a central area formed by the third planet gear set 154. When the second central sun gear 152 is driven (rotated) the second central sun gear 152 may drive (rotate) the third planet gear set 154.

When the third planet gear set 154 is driven (rotated), the third planet gear set 154 may drive (rotate) the third carrier 156. The third carrier 156 may have a central opening 158.

The transmission 140 may also include an arbor 160. A first end 160a of the arbor 160 may be received in the central opening 158 of the third carrier 156. The first end 160a of the arbor 160 may have a shape corresponding to the central opening 158 of the third carrier such that when the third carrier 156 rotates the third carrier 156 may drive (rotate) the arbor 160. A second end 160b of the arbor 160 may be received in an opening of the drive wheel 126 such that when the arbor 160 rotates the arbor 160 may drive (rotate) the drive wheel 126. The transmission 140 may include a first bearing 159. The transmission 140 may include a second bearing 161. A bottom cover 163 may enclose the transmission 140 from a bottom side of the bandsaw 100.

The transmission 140 may include a first ring gear 162. The first ring gear 162 may be a single piece of cast metal. The first planet gear set 142, the first carrier 144, the second planet gear set 148, and the second carrier 150 may be received within an interior volume of the first ring gear 162. When the first planet gear set 142 and the second planet gear set 148 are received in the first ring gear 162, teeth of the first planet gear set 142 and teeth of the second planet gear set 142 are engaged with teeth of the first ring gear 162 to enable relative movement between the first planet gear set 142 and the second planet gear set 148 and the first ring gear 162.

The transmission 140 may include a second ring gear 164. The second ring gear 164 may be a single piece of cast metal. The third planet gear set 154 and the third carrier 156 may be received within an interior volume of the second ring gear 164. When the third planet gear set 156 are received in the second ring gear 164, teeth of the third planet gear set 154 are engaged with teeth of the second ring gear 164 to enable relative movement between the third planet gear set 154 and the second ring gear 164.

The transmission housing 138 may receive and hold the first ring gear 162 and the second ring gear 164. The first ring gear 162 may include a set of tongues or lugs 166 on an exterior surface of the first ring gear 162. The second ring gear 164 may include a set of tongues or lugs 168 on an exterior surface of the second ring gear 164. The transmission housing 138 may include a set of channels or grooves 170 on an interior surface of the transmission housing 138. The set of channels 170 may receive and accept the set of tongues 166 of first ring gear 162 and may receive and accept the set of tongues 168 of the second ring gear 164. The set of tongues 166 of the first ring gear 162 are received in the set of channels 170 of the transmission housing 138 and affixes the first ring gear 162 to the transmission housing 138 and prevents the first ring gear 162 from moving (rotating) relative to the transmission housing 138. The set of tongues 168 of the second ring gear 164 are received in the set of channels 170 of the transmission housing 138 and affix the second ring gear 164 to the transmission housing 138 and prevents the second ring gear 164 from moving (rotating) relative to the transmission housing 138.

The size and shape of the first ring gear 162 and the second ring gear 164 are defined by the gear ratios between the first planet gear set 142 and the second planet gear set 148 and the third planet gear set 154. As the first planet gear set 142 and the second planet gear set 148 of the example bandsaw 100 have the same geometry and the same gear ratio, they are both able to use the first ring gear 162. However, as the third planet gear set 154 of the example bandsaw 100 has a different geometry and gear ratio than the first planet gear set 142 and the second planet gear set 148, the second ring gear 164 is necessary for the third planet gear set 154. In the example bandsaw 100, the first ring gear 162 has an interior diameter to accommodate the first planet gear set 142 and the second planet gear set 148 and the second ring gear 164 has an interior diameter to accommodate the third planet gear set 154. In the example bandsaw 100, the interior diameter of the second ring gear 164 is greater than the interior diameter of the first ring gear 162.

The first ring gear 162 has an exterior (outside) diameter. The second ring gear 164 has an exterior (outside) diameter. The exterior diameter of the first ring gear 162 and the exterior diameter of the second ring gear 162 are approximately equal. The transmission housing (receptacle) 138 has an interior diameter. The exterior diameter of the first ring gear 162, the exterior diameter of the second ring gear 164 and the interior diameter of the transmission housing 138 are approximately equal.

This configuration of the transmission 140 received in the integrated transmission housing 138 allows the base 110 of the bandsaw 100 to sink heat from the transmission 140. In other words, the base 110 acts as a heat sink for the transmission 140. This increases the life expectancy of the gears and any grease used to promote operation of the transmission 140.

### Roller in Blade Guard

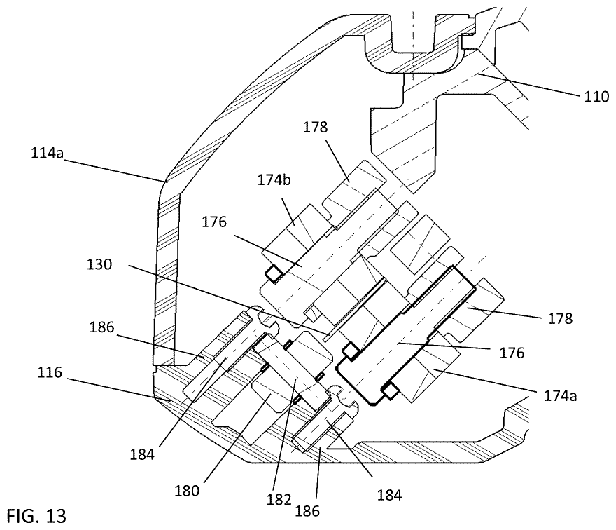

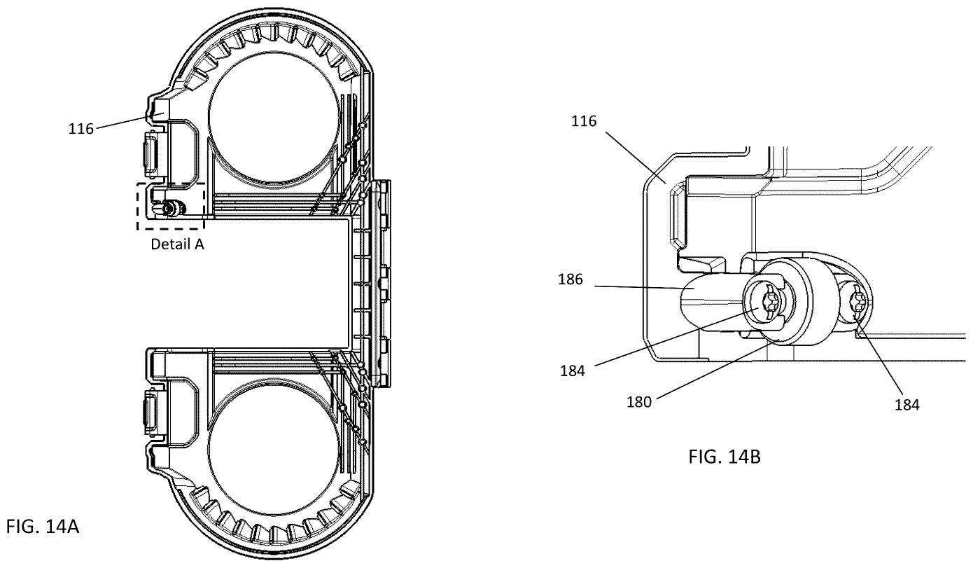

As noted above, the bandsaw 100 may include the blade 130. As illustrated in FIG. 13, the bandsaw 100 may also include at least a pair of blade rollers 174 assist in keeping the blade 130 aligned about the wheels 126, 128 and to assist in rotation of the blade 130. The pair of blade rollers 174 may include an interior blade roller 174a and an exterior blade roller 174b. The blade rollers 174 are rotatably coupled to the base 110 by a respective pair of screws 176. The pair of screws 176 are received in respective screw bosses 178. The blade rollers 174 are positioned adjacent to each other and the blade 130 passes between the adjacent blade roller 174. The blade rollers 174 may rotate about the respective screws 176 as the blade 130 rotates about the wheels 126, 128.

As noted above, the bandsaw 100 may include the blade guard 116 coupled to the base 110. The blade guard 116 may keep a user's hand from getting too close to or contacting the blade 130 in all areas except the cutting portion or throat 132 of the bandsaw 100 during normal operation. The blade guard 116 may be made of a metal material or a plastic material and may serve as a barrier between a user's hand and the blade 130.

The blade 130 of the bandsaw 100 is mounted onto two wheels—the drive wheel 126 which is driven by the motor 139 and the driven wheel 128 which is mechanically coupled to the drive wheel 126 by the blade 130. As the wheels 126, 128 rotate so does the blade 130. The drive wheel 126 is mechanically coupled to an output shaft 172 of the motor 139 through the arbor 160 and the transmission 140. As such, the drive wheel 126 is coaxial to the output shaft 172. The driven wheel 128 may be mounted to the base to enable the driven wheel 128 to translate relative to the drive wheel 126 (i.e., closer to and further from) for purposes of installing a blade 130 about the wheels 126, 128. The driven wheel 128 may be mounted in a way that it can be angularly adjusted, so if the drive wheel 126 and the driven wheel 128 are not axially parallel, the driven wheel 128 may be adjusted to be axially parallel to the drive wheel 126. This is a method of adjusting the tracking of the blade 130 of the bandsaw 100. This is to ensure that the blade 130 is positioned (tracked) correctly on the wheels 126, 128 and is running “true” on the wheels 126, 128. If the tracking of the blade 130 becomes out of alignment, the blade 130 may move (sometimes referred to as “walk”) relative to the wheels 126, 128 and the bandsaw 100 in general. In such a circumstance, the bandsaw 100 may be considered to be running abnormally, resulting in poor cutting performance, damage to the blade 130 or the bandsaw 100. Alternatively, the blade 130 may disengage from the wheels 126, 128 or the bandsaw 100 altogether.

The bandsaw 100 may a blade guard protection mechanism. The blade guard protection mechanism may be positioned in the blade guard 116. The blade guard protection mechanism may include a roller 180. The roller 180 may be of a metal material. As illustrated in FIG. 13, the roller 180 may receive a pin 182. The roller 180 and the pin 182 are configured such that the roller 180 may rotate about the pin 182. The roller 180 may include a bearing to enable the roller 180 to freely rotate (spin) about the pin 182. In other words, the pin 182 provides an axis of rotation for the roller 180. The pin 182 may be fixed to (mechanically coupled to) the blade guard 116 by a pair of screws 184. The screws 184 may be received in corresponding screw bosses 186 integrally formed in the blade guard 116. The axis of rotation of the roller 180 is generally perpending to the blade 130. The roller 180 may be positioned opposed to (in line with) a cutting side (teeth) of the blade 130, such that when the blade 130 is properly seated on the bandsaw 100/wheels 126, 128 there is a gap between the cutting side of the blade 130 and the roller 180. And, if the blade 130 moves from a proper seated position by more than a predetermined amount (the gap), for example 2 mm, the cutting side of the blade 130 will engage the roller 180—such engagement will cause the roller 180 to rotate about the pin 182. Any engagement between the blade 130 and the roller 180 may cause a sound to inform the user that the blade 130 has moved from its properly seated position.

If the blade 130 becomes misaligned (“walks out” off the wheels 126, 128), the blade 130 may contact the roller 180. The roller 180 may convert some of the cutting force into rotation of the roller 180. The roller 180 may keep the blade 130 from quickly cutting through the roller 180 and/or the blade guard 116. The sound created by the blade 130 engaging the roller 180 may provide a user with additional time to realize an issue has occurred.

Bandsaw Tire with Angled Chip Grooves and Angled Brush

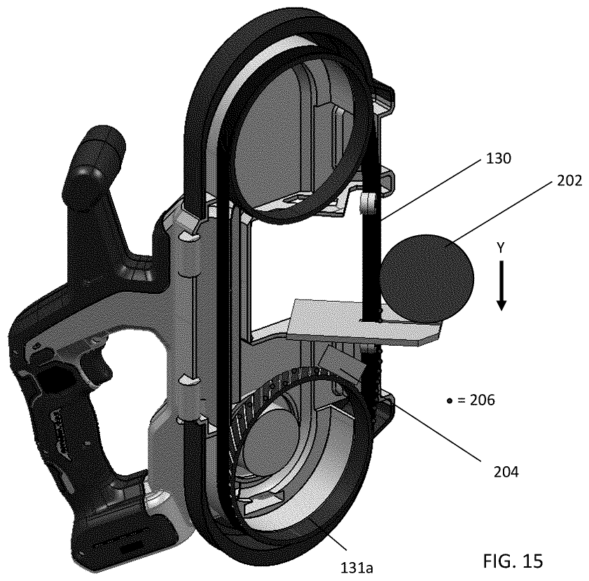

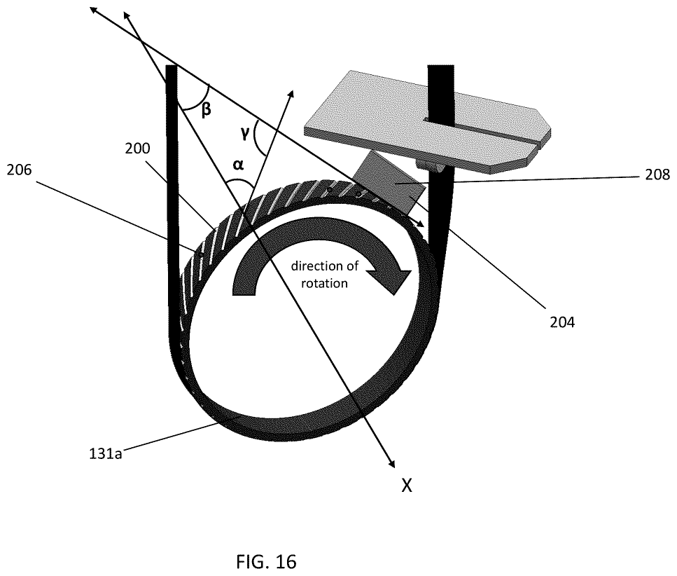

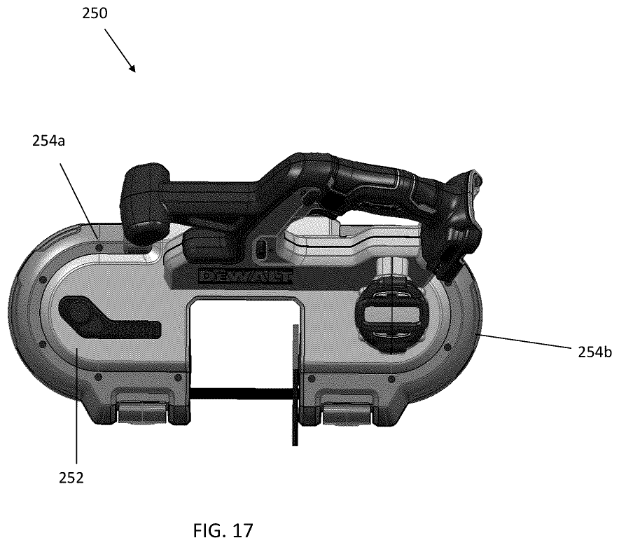

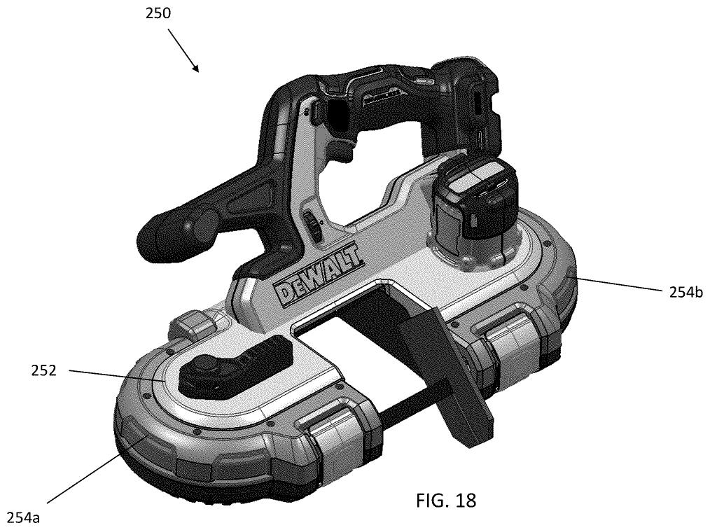

As illustrated in FIGS. 15 and 16, the example bandsaw 100 may include a series or set of grooves 200 molded into an outer surface of the tire 131a—the drive wheel 126 and the driven wheel 128 have been removed in FIGS. 15 and 16 to more clearly illustrate the features being described.

As illustrated in FIGS. 15 and 16, the bandsaw 100 may include a blade 130 that is mechanically driven by a drive wheel and a driven wheel. A tire 131a is positioned about the drive wheel and between the drive wheel and the blade 130 and a tire 131b is positioned about the driven wheel and between the driven wheel and the blade 130. During use, the blade 130 is positioned to cut a workpiece 202, for example, a metal pipe in cut direction Y. During operation/use the tire 131a will rotate about an axis of rotation X of the drive wheel 126/tire 131a in a direction of rotation. As a result of the cutting operation, metal chips may fall due to gravity and be carried by teeth of the blade 130. Some of the carried metal chips may be transferred to the tire 131a and can build up or become embedded in an outer surface of the tire 131a. This build-up of metal chips may lead to reduced contact and/or reduced friction between the blade 130 and the tire 131a. The reduced contact and/or friction may result in slippage of the blade 130 relative to the tire 131a. Such slippage may reduce the life of the blade and/or reduce the effectiveness of the cutting application.

The grooves 200 may be at an angle α to an axis of rotation X of the drive wheel 126/tire 131a. In a preferred embodiment, the angle α is approximately 50° to 70°. In a preferred embodiment, the angle α is approximately 60°. The bandsaw 100 may also include a brush 204. The brush 204 may be connected to the base 110. The brush 204 may be placed at an angle β to the axis of rotation X of the drive wheel 126/tire 131a. In a preferred embodiment, the angle β is approximately 20° to 40°. In a preferred embodiment, the angle β is approximately 30°. The brush 204 may be placed at an angle γ to the grooves 200. In a preferred embodiment, the angle γ is approximately 90°. In other words, a long axis of the grooves 200 is approximately perpendicular to a face 208 of the brush 204 and remains approximately perpendicular to the face 208 of the brush 204 as the tire 141a moves past the brush 204 during operation/rotation of the tire 131a.

The angled grooves 200 provide an area for the chips 206 to be moved into below an outer surface of the tire 126, e.g., sub-flush relative to the outer surface of the tire 131a. As such, the blade 130 may not press the chips 206 into the outer surface of the tire 131a. The brush 204 may sweep/brush the chips 206 out of the grooves 200 and off of the tire 131a. Because the tire 131a is rotating and the grooves 200 are at an angle to the axis of rotation of the tire 131a, a force vector is created against the stationary angled brush 204 which may direct chips 206 out of the tire 131a and the bandsaw 100.

### Double Wall Flexible Bumper

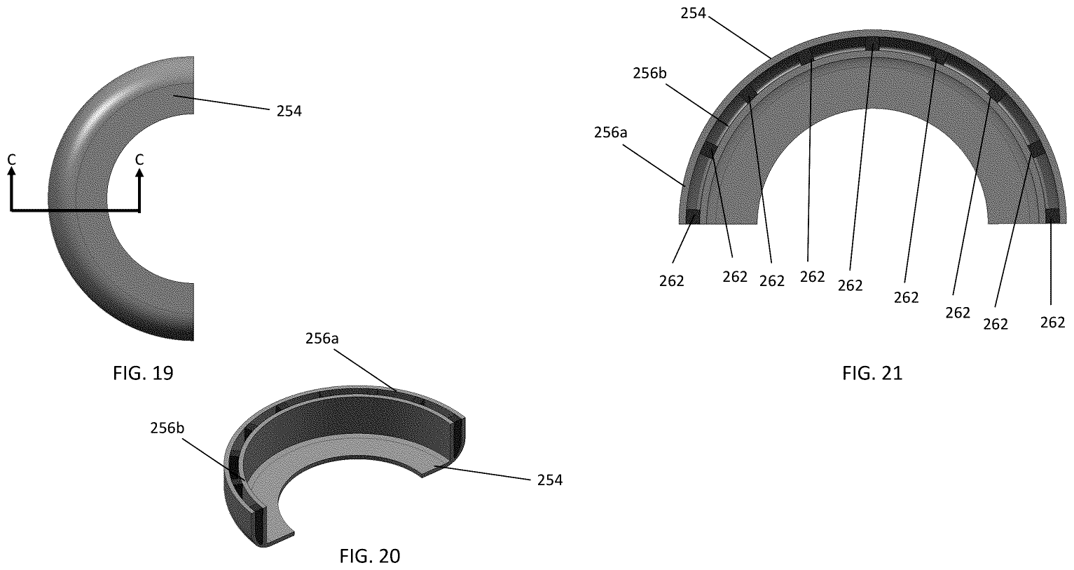

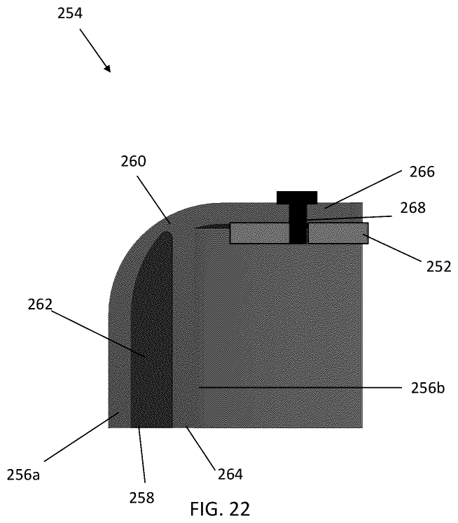

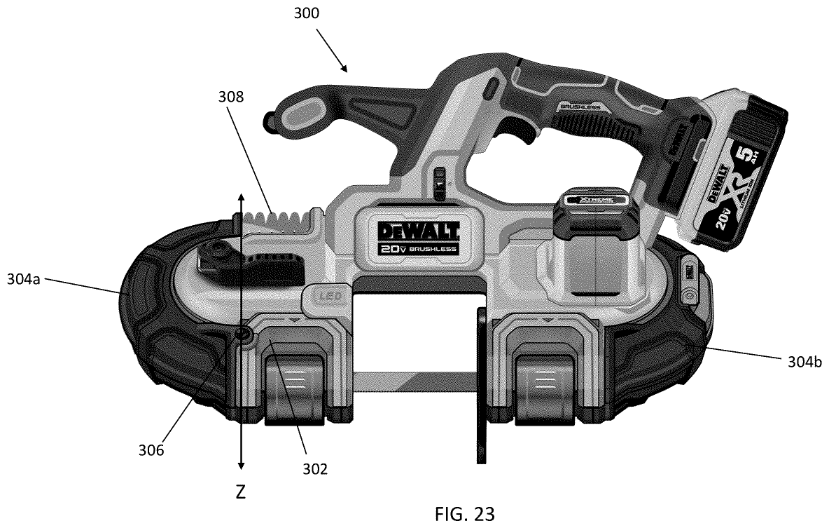

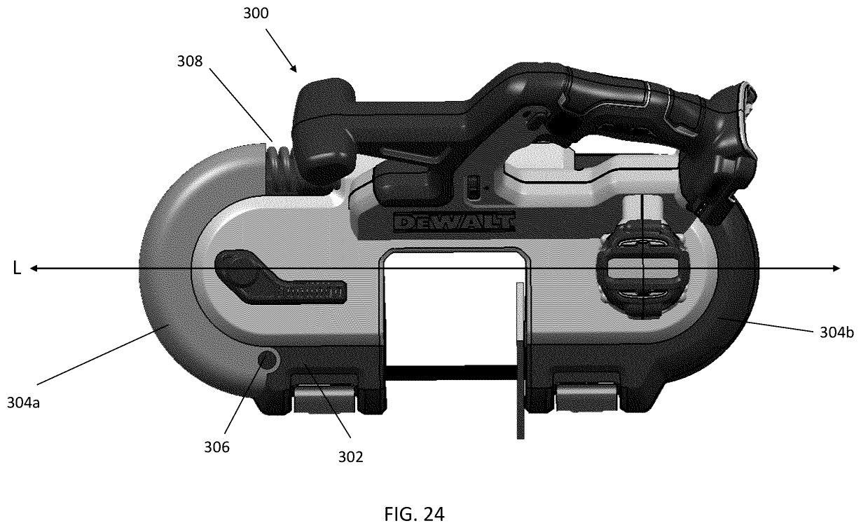

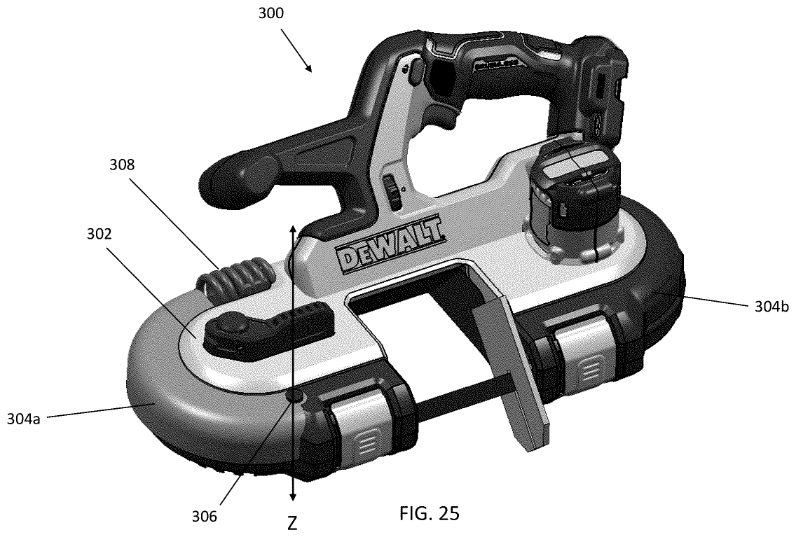

In an example bandsaw 250, the bandsaw 250 may include a base 252 and a first (forward/front) bumper 254a attached to the base 252 and a second (rearward/rear) bumper 254b attached to the base 252. The first bumper 254a and/or the second bumper 254b may include a double wall 256. As illustrated in FIGS. 19-22, the bumper 254 may include a first, outer wall 256a (sometimes referred to as an impact wall or rib) and a second, inner wall 256b (sometimes referred to as a support wall or rib). The outer wall 256a may be generally parallel to the inner wall 256b. A space or volume 258 is created or exists between the outer wall 256a and the inner wall 256b. The outer wall 256a and the inner wall 256b may be made of a first material, for example, a hard plastic such as ABS or polycarbonate.

A connection 260 between the outer wall 256a and the inner wall 256b enables the outer wall 256a to move (flex) relative to the inner wall 256b. The connection 260 may be a living hinge. The living hinge 260 may be modified in thickness and geometry to achieve different flex properties. A cross section of the living hinge 260 may be designed to have different thicknesses or geometries to modify the flex properties of the outer wall 256a.

The bumper 254 may also include a secondary (impact absorbing) material 262 may be positioned in the space/volume 258 between the outer wall 256a and the inner wall 256b to help absorb energy and control the amount of flex of the outer wall 256a to keep it within its elastic range. The durometer and the geometry of the impact absorbing material 262 may be selected to optimize the flexing of the outer wall 256a. The impact absorbing material 262 may be a basic rib design. The impact absorbing material 262 may be a rubber or soft plastic such as low-density polyethylene or high-density polyethylene. The impact absorbing material 262 may be placed at discrete locations about a circumference of the bumper 254. In an example embodiment, the impact absorbing material 262 is placed at nine discrete locations. In alternate embodiments, the impact absorbing material 262 may be placed at more or fewer locations. In alternate example embodiments, the impact absorbing material 262 may entirely fill the space 258 between the outer wall 256a and the inner wall 256b. The impact absorbing material 262 may extend from a face 264 of the bumper 254 to the living hinge 260. The impact absorbing material 262 may extend from the face 264 of the bumper 254 into the space 258 of the bumper 254 but not all the way to the living hinge 260. The impact absorbing material 260 may extend from a location inside the space 258 between the outer wall 256a and the inner wall 256b (recessed from the face 264) and extend to the living hinge 260.

The inner wall 256b may act as a foundation for the outer wall 256a and the secondary material 262 to flex against but also contributes an amount of flexibility to the bumper 254, in general. The bumper 254 may have a flange 266 to secure the bumper 254 to the bandsaw base 252 via one or more fasteners 268.

In an example process for forming the bumper 254, in a first molding step, the outer wall 256a and the inner wall 256b are formed. The outer wall 256a and the inner wall 256b may be made from a hard plastic, such as a nylon-based material. In a second molding step, the impact absorbing material 262 is injection molded into the space 258 between the outer wall 256a and the inner wall 256b. The impact absorbing material 262 may be made from a soft plastic or rubber.

### Hinged Bumper

In an example bandsaw 300, the bandsaw may include a base 302 and a first (forward/front) bumper 304a and a second (rearward/rear) bumper 304b. The bandsaw 300 may have a longitudinal axis L. The first bumper 304a may attach to the base 302 via a pivot pin 306. The pivot pin 306 may connect a first end of the first bumper 304a to the base 302 on a first side of the longitudinal axis L. The pivot pin 306 may define a pivot axis Z. The bandsaw 300 may also include a spring 308 coupling a second end of the first bumper 304a to the base on a second side of the longitudinal axis L—the second side of the longitudinal axis L be opposed to the first side of the longitudinal axis L. As described below, the spring 308 may absorb energy from a drop impact.

As illustrated in FIGS. 26A and 26B, when the bandsaw 300 is dropped and the first bumper 304a impacts the ground, compression of the spring 308 allows the bumper 304a to rotate about the pivot axis Z thereby converting a linear drop force into a rotational force. As illustrated in FIG. 26A, prior to a drop, the spring 308 is in a steady state position (or resting state) in which the spring 308 has a length M. As illustrated in FIG. 26B, after the drop, the spring 308 in an impact position (compressed state) in which the spring 308 has a length N, wherein N is less than M. The spring 308 does not need to be designed to absorb the entire drop impact force, but instead the spring 308 may have a sufficient compression spring load/deflection to keep the bumper 304 under a yielding limit and allow the bumper 304 to return to its pre-drop position. Additionally, due to the pivot axis Z the bumper 304 rotates about, the bandsaw 300 is well equipped to take impacts from many different orientations about an outer perimeter of the bumpers 304 and transfer the force to the spring 308.

The spring 308 and pivot pin 306 may also be included with the second bumper 304b.

### Hang Hook Guard Pivot

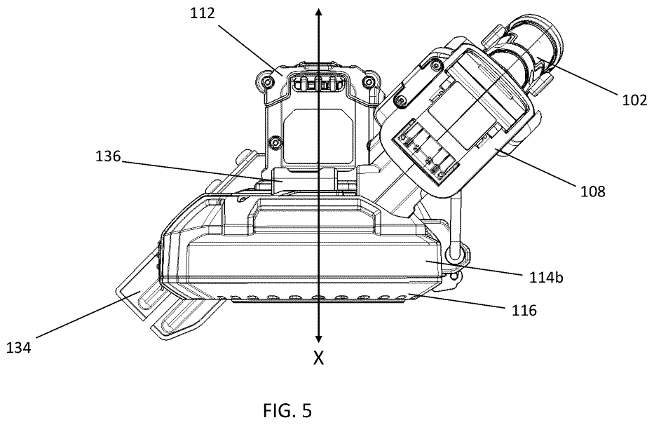

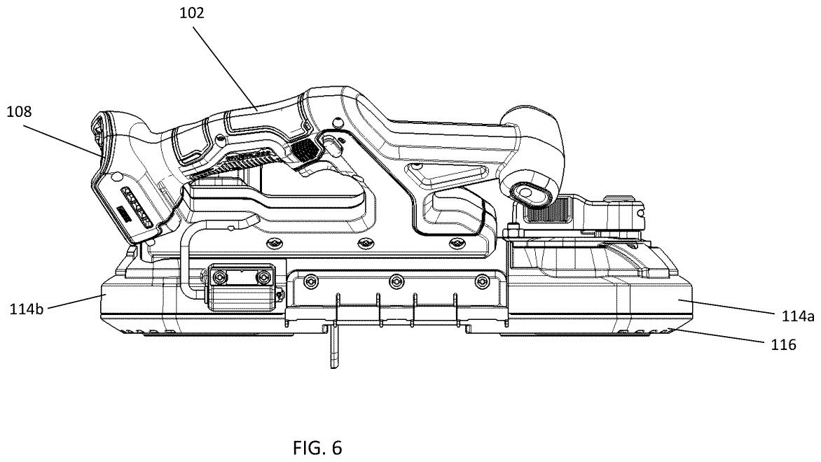

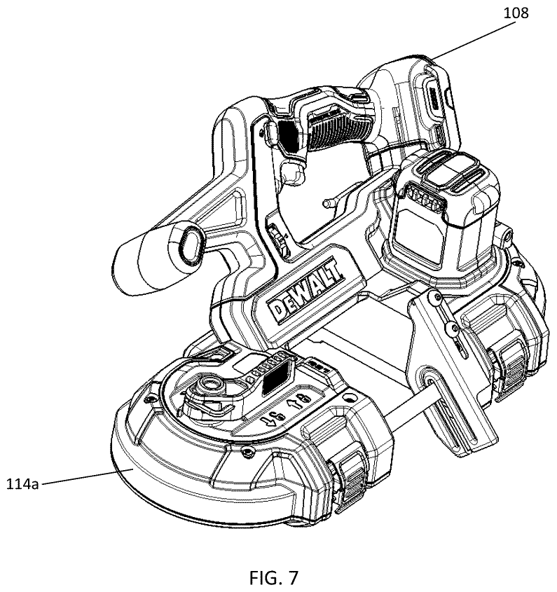

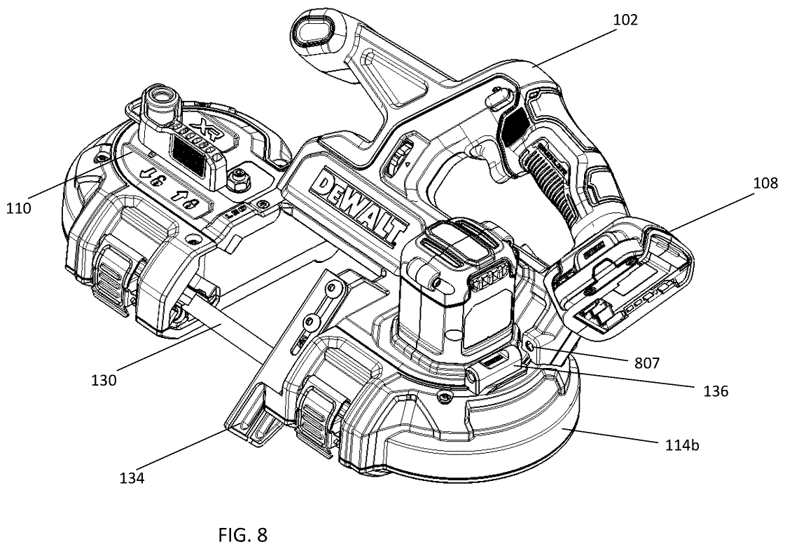

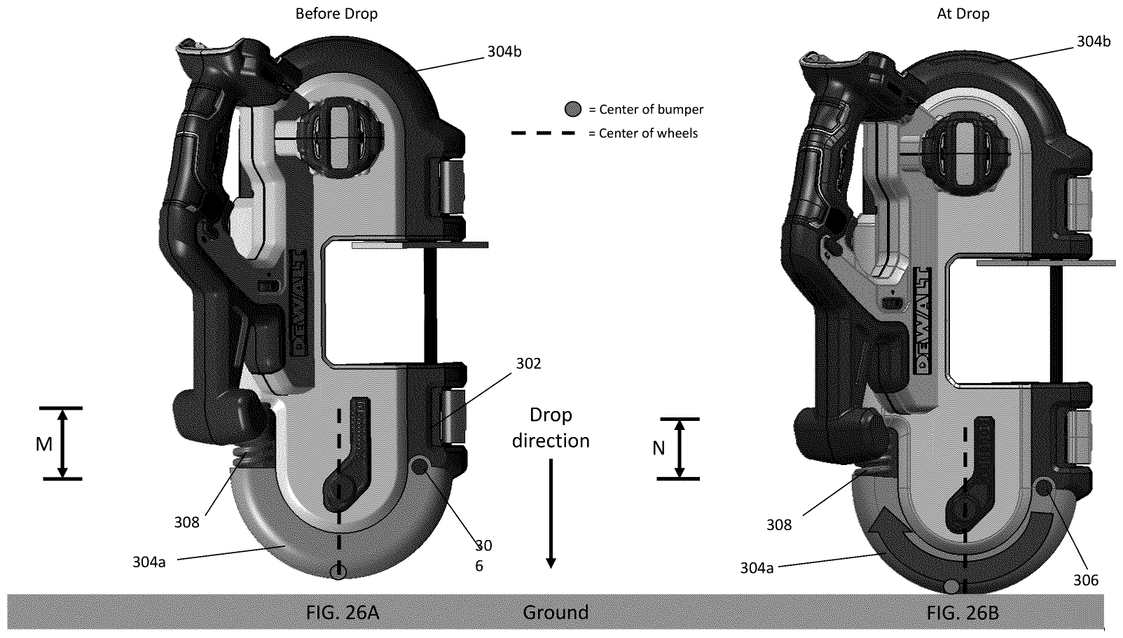

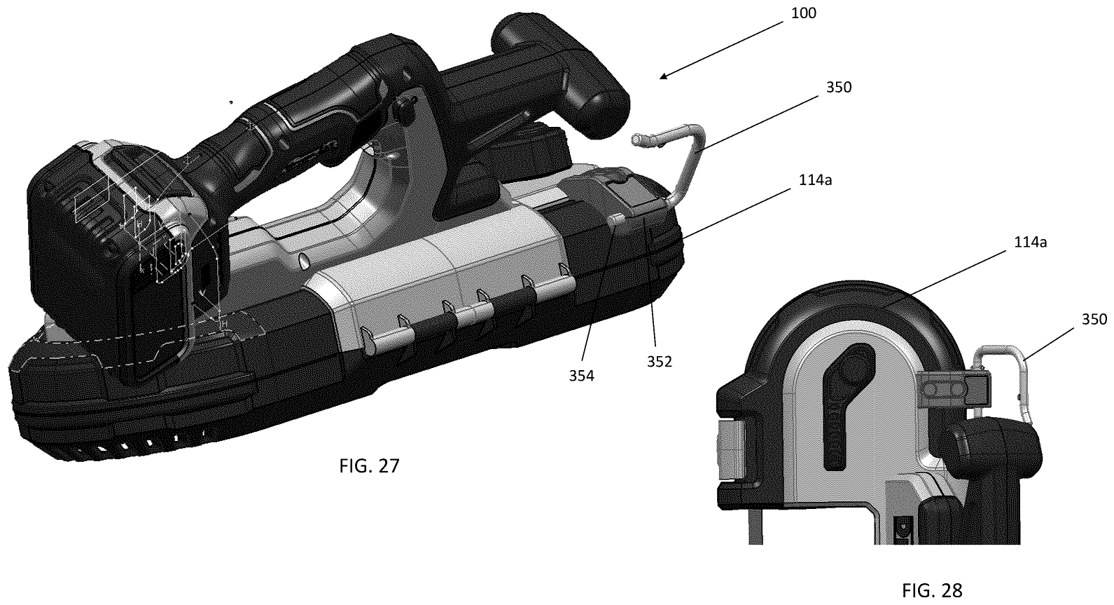

As illustrated in FIGS. 6, 27 and 28, an example bandsaw 100 may include a hang hook 350. The hang hook 350 may be coupled to a forward bumper 114a but a connector 352. A first leg 354 of the hang hook 350 may be received in a through hole of the connector 352. The hang hook 350 may be rotatable, about a rotation axis of the first leg 354, to be placed in a first, stowed (storage) position or a second, hang position.

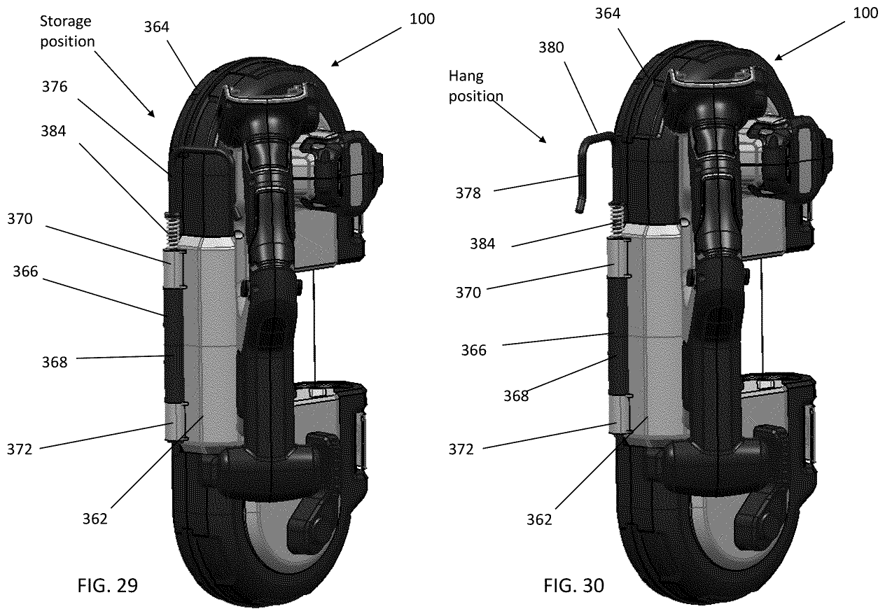

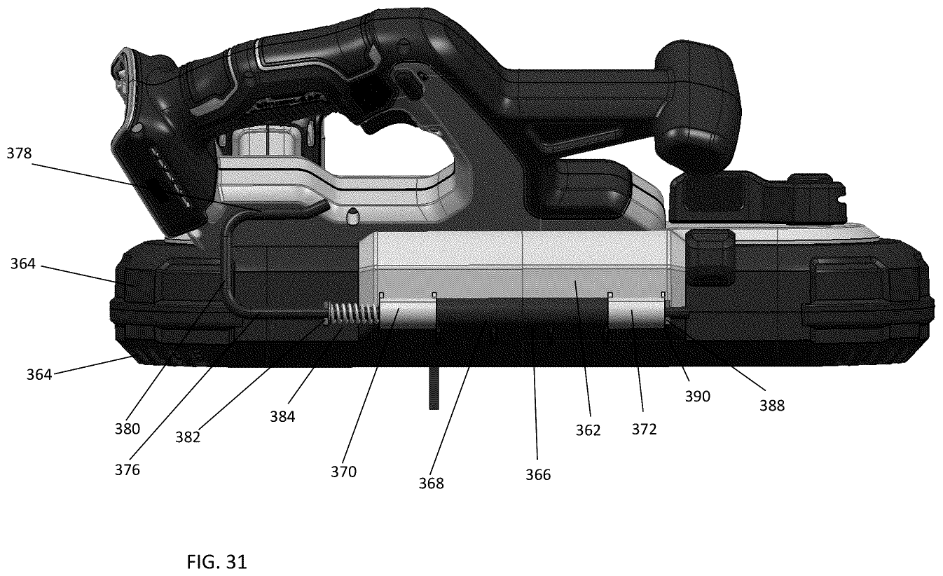

As illustrated in FIGS. 29-32, an alternate example bandsaw 360 may include a base 362 and a blade guard 364. The blade guard 364 may be coupled to the base 362 by a hinge 366. The hinge 366 may include a blade guard hinge element 368, a first hinge element 370 of the base 362 and a second hinge element 372 of the base 362. The bandsaw 360 may include a hang hook 374. The hang hook 374 may include a first (long) leg 376, a second (short) leg 378 and a connecting leg 380 that connects the long leg 376 and the short leg 378 to form a hook for hanging the bandsaw 360. The long leg 376 of the hang hook 374 may be a pivot pin for the hinge 366. The long leg 376 may be received in the blade guard hinge element 368, the first base hinge element 370 and the second base hinge element 372 to enable the blade guard 364 to rotate about the long leg 376 relative to the base 362. As illustrated in FIG. 29, the hang hook 374 may be rotatable, about a rotation axis of the long leg 376, to be placed in a first, stowed (storage) position. As illustrated in FIG. 30, the hang hook 374 may be rotatable, about a rotation axis of the long leg 376, to be placed in a second, hang position. The long leg 376 may have a pin, shoulder or flange 382. A spring 384 may be positioned about the long leg 376. The spring 384 may be positioned between the flange 382 and the first base hinge element 370. The long leg 376 may have a pin 388 at an end extending generally perpendicularly to a long axis of the long leg 376. The pin 388 may extend radially outward from opposing sides of the long leg 376. A detent feature 390 may be molded or machined into an end of the second base hinge element 372. The detent feature 390 may have two distinct detents. The spring 384 may apply a force against the flange 382 such that the pin 388 presses against the end of the second base hinge element 372 yet allows the long leg 376 to rotate within the hinge 366. When the hang hook 374 is in the first position, the pin 388 will be received in one of the two distinct detents and when the hang hook 374 is in the second position, the pin 388 will be received in the other of the two distinct detents. The spring 384 may ensure that the pin 388 remains engaged in the selected detent 390.

The blade guard pivot pin location also offers improved hang hook storage locations, keeping it safe from drop impacts. Because the hang hook has a larger diameter than the standard guard pivot pin, it should offer better durability. Because the hang hook 368 is located at the blade guard 364 pivot point, it will not interfere with the blade guard 364 opening up fully.

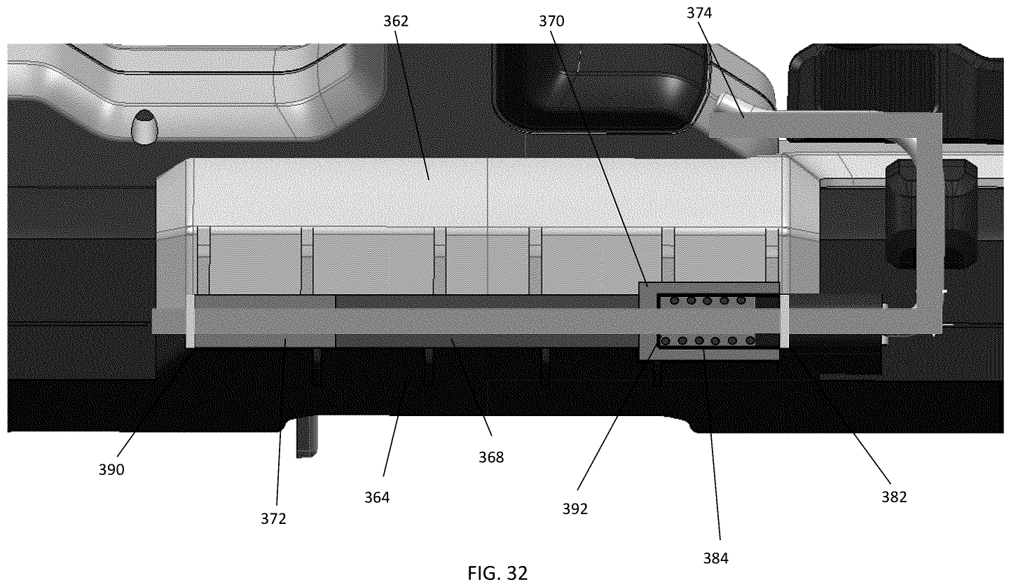

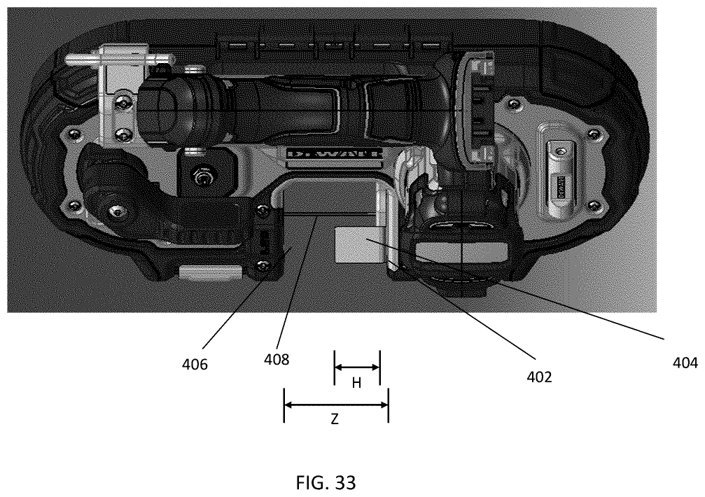

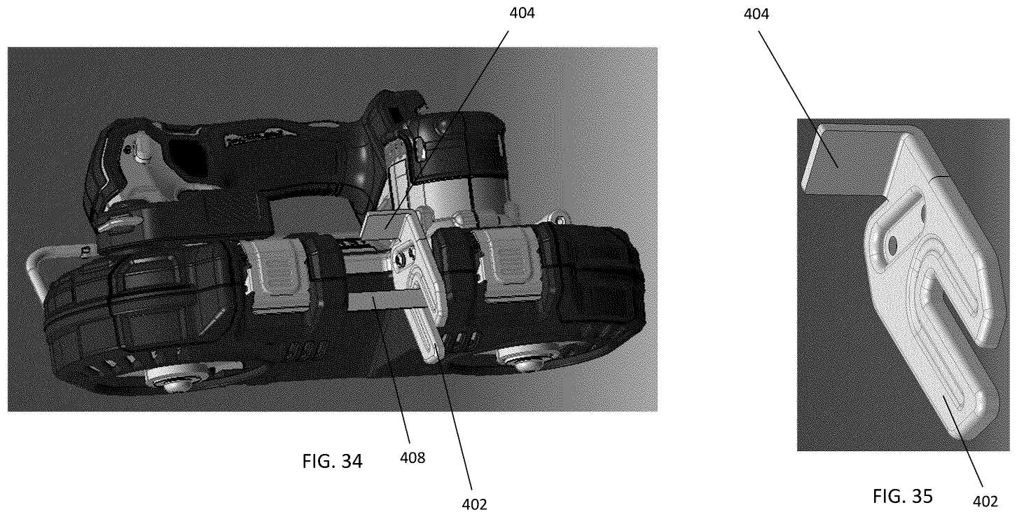

As illustrated in FIG. 32, in an alternate example embodiment of the hang hook 374, the first base hinge element 370 may include a pocket 392 to receive the spring 384. Similar to the aforementioned embodiment, the spring 384 presses (applies a force) against the shoulder 382 at one end and an interior end of the pocket 392 to keep the pin 388 within a selected detent 390.

Shoe with Integrated Material Catch

In an example embodiment, a bandsaw 400 may include a shoe 402. The shoe 402 may include an integral material catch 404. The catch 404 may stop the bandsaw 400 from falling forward after completing a cut. The shoe 402 and the material catch 404 may be formed of a single material. The shoe 402 and the material catch 404 may be formed of a metal material. The shoe 402 and the material catch 404 may be formed in a single casting.

The bandsaw 400 may have a throat 406. The bandsaw 400 may include a blade 408 that passes through the throat 406 to cut a workpiece. The throat 406 may define a cut capacity of the bandsaw 400. The cut capacity of the bandsaw may have a dimension Z. The catch 404 may have a height dimension H. The height dimension H of the catch 404 may be sized to approximately half the cut capacity dimension Z to keep work pieces from moving beyond the throat towards the user.

### Tethering Attachment Assembly

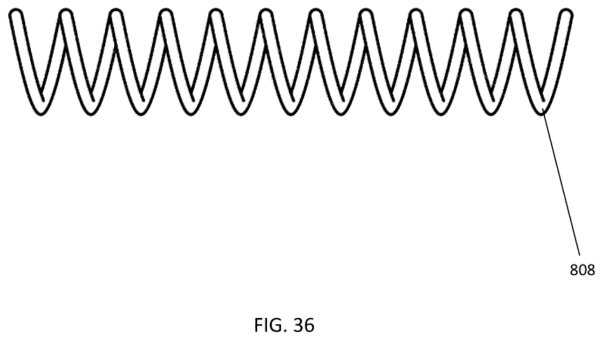

As illustrated, for example, in FIGS. 36-42B, the present disclosure provides an example tethering attachment assembly 800 for attachment to an apparatus to facilitate connection of a lanyard to the apparatus. The present disclosure also provides an example method of manufacturing the tethering attachment assembly 800. The present disclosure also provides an example method of attaching the tethering attachment assembly 800 to an apparatus. The bandsaw 100 is an example apparatus on which the tethering attachment assembly 800 may be used. The tethering attachment assembly 800 may be used on other apparatuses such as circular saws and drills. The tethering attachment assembly 800 may provide an attachment point for the user to attach a lanyard in order to protect the tool in the event of a fall. The advantages of this tethering attachment assembly 800 are discussed in detail below.

The tethering attachment assembly 800 may be removably attached to the tethering attachment assembly connection boss 136 positioned at a rear end of the base 110 of the bandsaw 100. The connection boss 136 may be integrally formed with the base 110. The connection boss 136 may include a through hole 804 to receive at least one screw 806, as discussed in more detail below. The handle assembly 102 may include a receiving screw nut 807 formed therein. The screw nut 807 may be aligned with the through hole 804 to receive and hold an end of the screw 806.

The tethering attachment assembly 800 may include a coil element 808. The coil element 808 may be made of an elastic metal material in the form of a coil spring or a compression spring designed and treated to be deformable upon application of a force.

The tethering attachment assembly 800 may further include a wire 810 positioned within the coil element 808. The wire 810 may be made of a metal material. The wire 810 may be made of a steel material. The wire 810, positioned within the coil element 808 assists in evenly distributing forces applied to the coil element 808 during a fall.

The tethering attachment assembly 800 may further include a fabric cover (sleeve) 812. The sleeve 812 may be made of a webbing of material, e.g., nylon, ballistic nylon, synthetic fiber, polypropylene, or cotton, or of plastic material. The sleeve 812 may substantially cover the coil element 808. The sleeve 812 may be tubularly disposed around the coil element 882 and fastened to the coil element 808 to restrain the coil element 808 from being stretched under normal use operation. However, in the event of a fall at height, the sleeve 812 may tear away under heavy stress, in which case the coil element 808 may irreparably deform and be exposed to the user.

The coil element 808 may include extended portions (ears) 814 formed to attach the tethering attachment assembly 800 to the tethering attachment assembly connection boss 136 by the screw 806.

The tethering attachment assembly 800 may also include a secondary sleeve (heat shrink cap/end) 816, such as a heat-shrink tubing, is disposed at each end of the sleeve 812.

The tethering attachment assembly 800 may also include a bushing 818 on each ear 814 of the coil element 808.

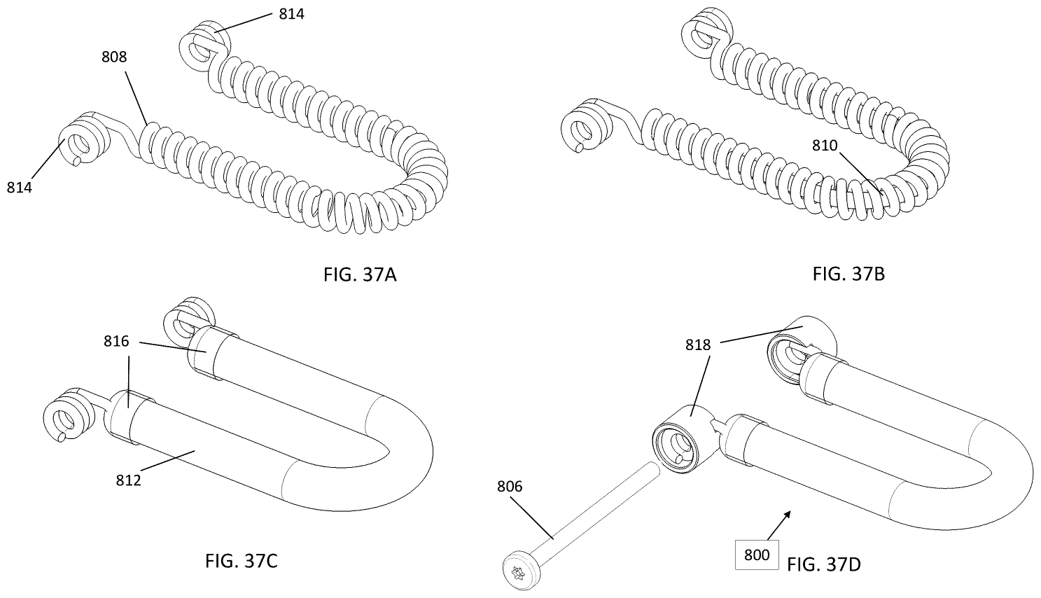

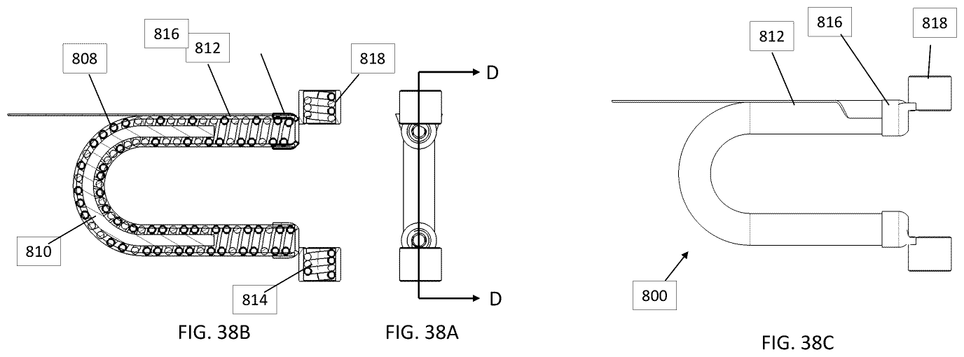

An example method of manufacturing the tethering attachment assembly 800 may include a step of providing a coil spring 808, a step of bending the coil spring 808 to form a u-shape (FIG. 37A), a step of bending ends of the coil spring 808 to form the spring ears 814 (FIG. 37A), a step of inserting the wire 810 into a main body 808a of the coil spring 808 (FIG. 37B), a step of placing the sleeve 812 over the main body 808a of the coil spring 808 (FIG. 37C), a step of placing the heat shrink end 816 on ends of the main body 808a of the coil spring 808 such that the heat shrink end 816 overlaps the sleeve 812 (FIG. 37C), and a step of pressing the bushing 818 onto each ear 814 of the coil spring 808 (FIG. 37D). The completed tethering attachment assembly 800 is illustrated in FIGS. 38A and 38C.

Another example method of manufacturing the tethering attachment assembly 800 may include a step of providing a coil spring 808, a step of inserting the wire 810 into the coil spring 808 (FIG. 37B), a step of bending the coil spring 808 to form a u-shape (FIG. 37A), a step of bending ends of the coil spring 808 to form the spring ears 814 (FIG. 37A) and a main body 808a of the coil spring 808, a step of placing the sleeve 812 over the main body 808a of the coil spring 808 (FIG. 37C), a step of placing the heat shrink end 816 on ends of the main body 808a of the coil spring 808 such that the heat shrink end 816 overlaps the sleeve 812 (FIG. 37C), and a step of pressing the bushing 818 onto each ear 814 of the coil spring 808 (FIG. 37D).

The tethering attachment assembly 800 may be attached to a tethering attachment assembly ready tool. The bandsaw 100 is an example tethering attachment assembly ready tool onto which the tethering attachment assembly 800 may be attached/used. The tethering attachment assembly may be used on other tethering attachment assembly ready tools such as circular saws and drills.

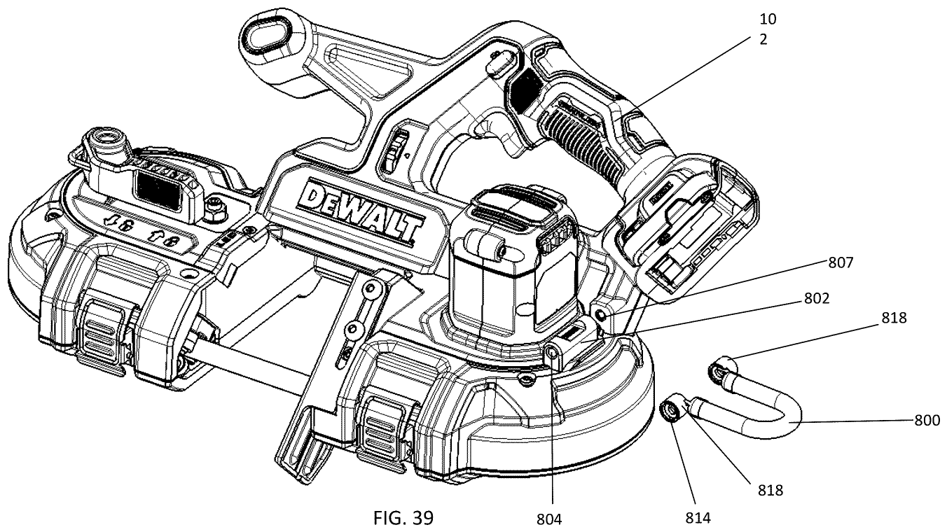

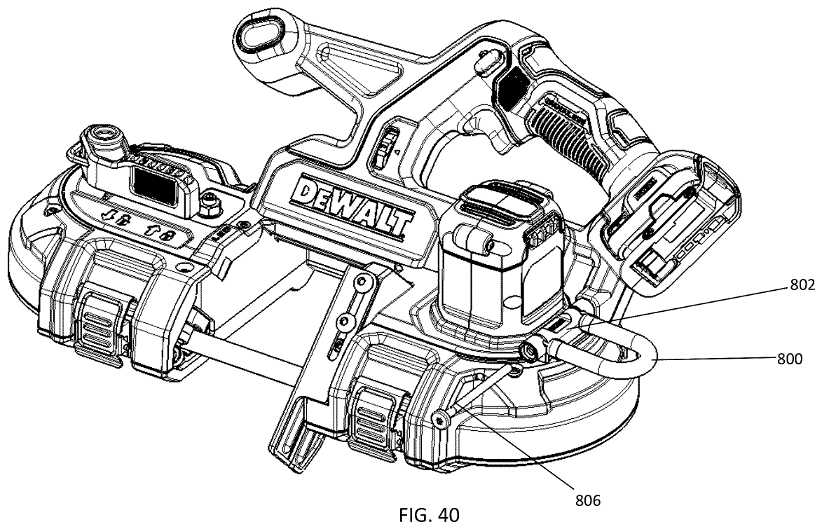

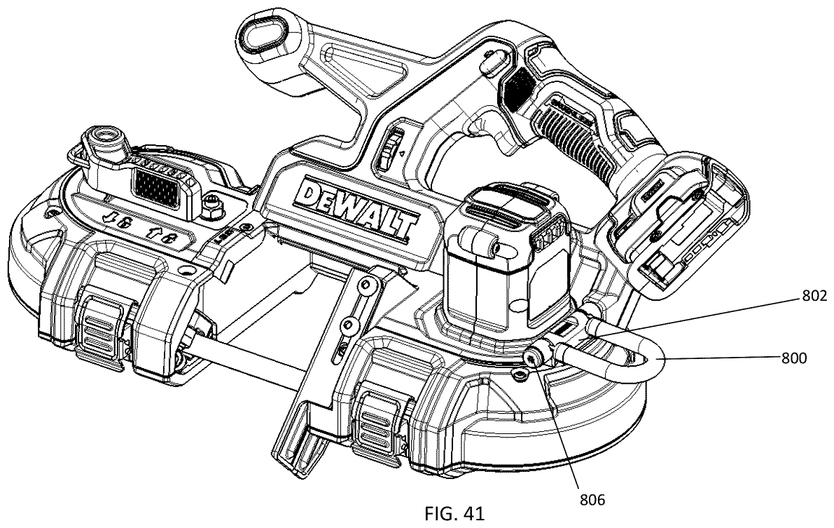

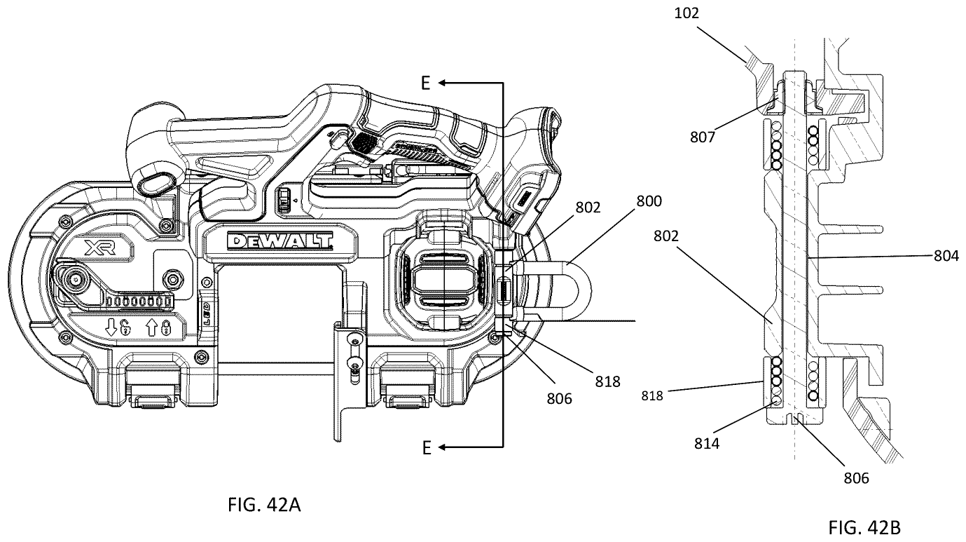

An example method of attaching the tethering attachment assembly 800 to the bandsaw 100 may include a step of providing a tethering attachment assembly ready bandsaw 100 and a tethering attachment assembly 800 (FIG. 39), a step of aligning the spring ears 814/bushings 818 of the tethering attachment assembly 800 with the through hole 804 of the tethering attachment assembly screw boss 136 (FIG. 40), a step of installing the screw 806 through the spring ears 814/bushings 818 and the tethering attachment assembly screw boss 136 and screwing the screw 806 into the screw nut 807 (FIGS. 41, 42A, 42B).

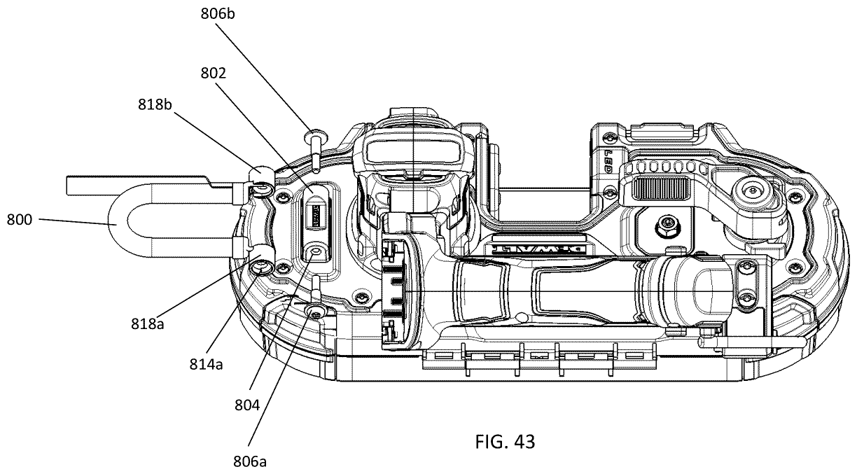

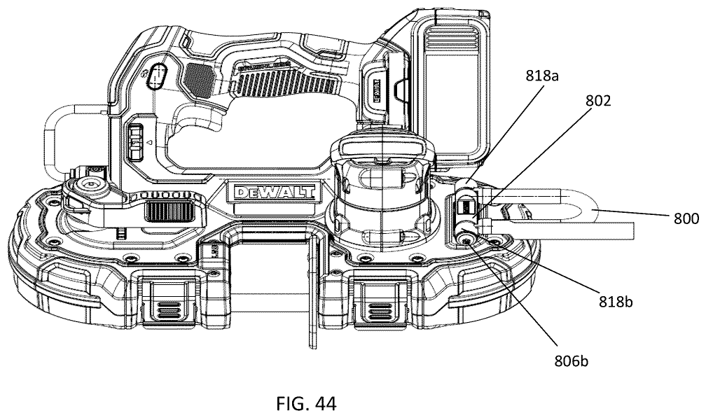

Another example method of attaching the tethering attachment assembly 800 to the bandsaw 100′ may include a step of providing a tethering attachment assembly ready bandsaw 100′ and a tethering attachment assembly 800 (FIG. 43), a step of aligning the spring ears 814/bushings 818 of the tethering attachment assembly 800 with the through hole 804 of the tethering attachment assembly screw boss 136, a step of installing a first screw 806a through the first spring ear 814a/bushing 818a and into the through hole 804 of the tethering attachment assembly connection boss 136, and a step of installing a second screw 806b through the second spring ear 814b/bushing 818b and into the through hole 804 of the tethering attachment assembly connection boss 136 (FIG. 44).

A lanyard may be attached to the tethering attachment assembly 800 (e.g., directly or via a carabiner) when the bandsaw 100 is in use at higher grounds. As understood in the industry, and for the purposes of this disclosure, a lanyard may refer to any cable, strap, rope or cord, typically with “ready to use” terminations such as hooks or carabiners, intended for securing objects for “at height” use.

Numerous modifications may be made to the exemplary implementations described above. These and other implementations are within the scope of this application.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A bandsaw, comprising:
a motor,
a transmission coupled to the motor,
a base, the base including an integrated transmission housing, the transmission received in the integrated transmission housing,
a drive wheel, the drive wheel coupled to the transmission,
a driven wheel,
a blade positioned about the drive wheel and the driven wheel.

2. The bandsaw as recited in claim 1, further comprising a cover attached to an outer opening of the transmission housing.

3. The bandsaw as recited in claim 2, wherein the cover includes a central opening to receive a motor output gear.

4. The bandsaw as recited in claim 1, wherein the transmission includes a first planet gear set and a first carrier, the first planet gear set received on a first side of the first carrier, the motor output gear received within a central area formed by the first planet gear set in driving communication with the first planet gear set.

5. The bandsaw as recited in claim 4, wherein the first carrier includes a first central sun gear on a second side of the first carrier, the second side of the first carrier being opposed to the first side of the first carrier, the first planet gear set in driving communication with the first carrier and the first central sun gear.

6. The bandsaw as recited in claim 5, wherein the transmission includes a second planet gear set and a second carrier, the second planet gear set received on a first side of a second carrier, the first central sun gear received within a central area formed by the second planet gear set in driving communication with the second planet gear set.

7. The bandsaw as recited in claim 6, wherein the second carrier includes a second sun gear on a second side of the second carrier, the second side of the second carrier being opposed to the first side of the second carrier, the second planet gear set in driving communication with the second carrier and the second central sun gear.

8. The bandsaw as recited in claim 7, wherein the transmission includes a third planet gear set and a third carrier, the third planet gear set received on a first side of a third carrier, the second central sun gear received within a central area formed by the third planet gear set in driving communication with the third planet gear set.

9. The bandsaw as recited in claim 8, wherein the third carrier includes a central opening, the third planet gear set is in driving communication with the third carrier.

10. The bandsaw as recited in claim 9, wherein the transmission includes an arbor, the arbor including a first end, the first end of the arbor received in the central opening of the third carrier, such that the third carrier is in driving communication with the arbor.

11. The bandsaw as recited in claim 10, wherein the first end of the arbor has a shape corresponding to the central opening of the third carrier such that when the third carrier rotates the third carrier drives the arbor.

12. The bandsaw as recited in claim 11, wherein the arbor includes a second end received in an opening of the drive wheel in driving communication with the drive wheel.

13. The bandsaw as recited in claim 12, wherein the transmission includes a first ring gear and wherein the first planet gear set, the first carrier, the second planet gear set, and the second carrier are received within an interior volume of the first ring gear.

14. The bandsaw as recited in claim 13, wherein teeth of the first planet gear set and teeth of the second planet gear set are engaged with teeth of the first ring gear to enable relative movement between the first planet gear set and the second planet gear set and the first ring gear.

15. The bandsaw as recited in claim 14, wherein the transmission includes a second ring gear and wherein the third planet gear set and the third carrier are received within an interior volume of the second ring gear.

16. The bandsaw as recited in claim 15, wherein teeth of the third planet gear set are engage with teeth of the second ring gear to enable relative movement between the third planet gear set and the second ring gear.

17. The bandsaw as recited in claim 16, wherein the transmission housing receives and holds the first ring gear and the second ring gear.

18. The bandsaw as recited in claim 17, wherein the first ring gear includes a set of tongues on an exterior surface of the first ring gear and the transmission housing includes a set of channels on an interior surface of the transmission housing, the set of tongues of the first ring gear received in the set of channels of the transmission housing thereby preventing the first ring gear from moving relative to the transmission housing.

19. The bandsaw as recited in claim 18, wherein the second ring gear includes a set of tongues on an exterior surface of the second ring gear and the transmission housing includes a set of channels on an interior surface of the transmission housing, the set of tongues of the second ring gear received in the set of channels of the transmission housing, thereby preventing the second ring gear from moving relative to the transmission housing.

20. The bandsaw as recited in claim 19, wherein the first ring gear has an exterior diameter and the second ring gear has an exterior diameter, the exterior diameter of the first ring gear and the exterior diameter of the second ring gear being approximately equal and the transmission housing has an interior diameter, the exterior diameter of the first ring gear, the exterior diameter of the second ring gear and the interior diameter of the transmission housing being approximately equal.
